(19) United States
(12) Patent Application Publication
(10) Pub. No.: US 2015/0347914 A1
(43) Pub. Date: Dec. 3, 2015

(54) METHOD FOR DATA PARALLEL INFERENCE AND APPARATUS THEREOF

(71) Applicant: Electronics and Telecommunications Research Institute, Daejeon (KR)

(72) Inventors: Soon-Hyun KWON, Incheon (KR); Yoon-Sik YOO, Daejeon (KR); Mal-Hee KIM, Daejeon (KR); Dong-Hwan PARK, Daejeon (KR); Hyo-Chan BANG, Daejeon (KR)

(21) Appl. No.: 14/556,020

(22) Filed: Nov. 28, 2014

(30) Foreign Application Priority Data
May 27, 2014 (KR) 10-2014-0064000

(51) Int. Cl. G06N 5/04; G06F 17/30

(52) U.S. Cl. CPC G06N 5/047; G06F 17/30321

(57) ABSTRACT

Exemplary embodiments of the present invention relate to a method and apparatus for big data parallel inference. A method for data parallel inference according to an embodiment of the present invention comprises generating a predetermined network comprising a pattern network and a join network based on rule files and a predetermined algorithm; performing a pattern matching test for input data in parallel on a plurality of pattern matching means by loading the pattern network to each of the plurality of pattern matching means and distributing the inputted data to the plurality of pattern matching means; and inferring new data by performing a join matching test for the data which has passed the pattern matching test. According to embodiments of the present invention, new data can be inferred by analyzing accurately and fast big data.

### CROSS REFERENCE TO RELATED APPLICATION

This application claims the benefit of Korean Patent Application No. 10-2014-0064000, filed on May 27, 2014, entitled “Data parallel inference method and apparatus thereof”, which is hereby incorporated by reference in its entirety into this application.

### BACKGROUND

1. Technical Field

The present invention relates to a method and apparatus for big data parallel inference.

2. Description of the Related Art

There is a large demand particularly for processing and analyzing big data as the data gets bigger due to explosive spread of electronic devices such as smart phones and tablets, etc., proliferation of Internet of Things(IoT, or Web of Things(WoT)) and cloud computing technology, and prevalence of social network service-based services.

Particularly, since data periodically sensed from various sensors in IoT environment has become bigger and more complicated to process and store, a great deal of research has been developed to resolve such problems.

Currently, attention has been focused on technologies to use internet as a gigantic cloud to derive values of new data through data sharing and mashup in IoT environment. In response to this trend, interests in semantic web technologies, whose purpose is to establish web which both human and computer can understand well when the computer itself determines and performs processing automation of a variety of information resources, and data integration and reusability by implementing well-defined semantic Interoperability based on the conventional web, have increased. However, traditional inference methods cannot ensure the inference performance, thereby being difficult to apply data to actual services as data becomes bigger and bigger.

### SUMMARY

Exemplary embodiments of the present invention are to provide a method for efficient big data inference.

Exemplary embodiments of the present invention are to provide an improved inference method for RDFS-based big data in IoT environment.

A method for data parallel inference according to an embodiment of the present invention may comprise generating a predetermined network comprising a pattern network and a join network based on rule files and a predetermined algorithm; performing a pattern matching test for input data in parallel on a plurality of pattern matching means by loading the pattern network to each of the plurality of pattern matching means and distributing the inputted data to the plurality of pattern matching means; and inferring new data by performing a join matching test for the data which has passed the pattern matching test.

In an embodiment, the generating a predetermined network may comprise: forming information to be used for the pattern matching test and the join matching test by analyzing condition part of each rule included in the rule files; and generating a predetermined network by using the formed information.

In an embodiment, the information to be used for the pattern matching test may comprise at least one of identification information of each pattern composing the condition part, token information included in a corresponding pattern, information indicating whether the pattern matching test for a corresponding pattern is performed or not, and an operation expression which is used at the time of the pattern matching test for a corresponding pattern.

In an embodiment, the information to be used for the join matching test may comprise at least one of identification information of the join matching test to be performed for a corresponding rule and an operation expression which is used at the time of the join matching test for the condition part.

In an embodiment, the generating a predetermined network may comprise, when a token having a constant value exists in a pattern, generating a pattern node which performs the pattern matching test for the corresponding token on the pattern network.

In an embodiment, the generating a predetermined network may comprise, when tokens having the same variable value exist in one pattern, generating a pattern node which performs the pattern matching test for the corresponding token on the pattern network.

In an embodiment, the generating a predetermined network may comprise, when tokens having the same variable value exists in common in patterns included in one condition part, generating a join node which performs the join matching test for the corresponding token on the join network.

In an embodiment, the performing a pattern matching test may comprise: loading the join network to one join matching means; and performing the join matching test using the data which has passed the pattern matching test and the inputted data, on the join matching means.

In an embodiment, the method may further comprise indexing the result from the pattern matching test and the join matching test to each of the pattern node and the join node.

In an embodiment, the method may further comprise distributing the inferred new data to the plurality of pattern matching means.

In an embodiment, the predetermined algorithm may be a Rete algorithm, the predetermined network may be a Rete network, and the condition part may be left hand side(LHS).

An apparatus for data parallel inference according to an embodiment of the present invention comprises a processor and a memory, wherein the memory stores commands to generate a predetermined network and perform data parallel inference, in which the commands may comprise, when performed by the processor, commands for the processor to: generate a predetermined network comprising a pattern network and a join network based on rule files and a predetermined algorithm; perform a pattern matching test for input data in parallel on a plurality of pattern matching means by loading the pattern network to each of the plurality of pattern matching means and distributing the inputted data to the plurality of pattern matching means; and infer new data by performing a join matching test for the data which has passed the pattern matching test.

In an embodiment, the commands may comprise commands for the processor to form information to be used for the pattern matching test and the join matching test by analyzing condition part of each rule included in the rule files; and generate a predetermined network by using the formed information.

In an embodiment, the commands may comprise commands for the processor to generate a pattern node which performs the pattern matching test for a token on the pattern network, the token having a constant value.

In an embodiment, the commands may comprise commands for the processor to generate a pattern node which performs the pattern matching test for tokens on the pattern network, the tokens having the same variable value in one pattern.

In an embodiment, the commands may comprise commands for the processor to generate a join node which performs the join matching test for tokens on the join network, the token having the same variable value in in patterns included in one condition part.

In an embodiment, the commands may comprise commands for the processor to load the join network to one join matching means; and perform the join matching test using the data which has passed the pattern matching test and the inputted data, on the join matching means.

In an embodiment, the commands may comprise commands for the processor to index the result from the pattern matching test and the join matching test to each of the pattern node and the join node.

In an embodiment, the command may comprise commands for the processor to distribute the inferred data to the plurality of pattern matching means.

In an embodiment, the predetermined algorithm may be a Rete algorithm, the predetermined network may be a Rete network, and the condition part may be left hand side(LHS).

The present invention according to embodiments allows inferring new data by fast and accurately analyzing big data.

The present invention according to embodiments allows improving performance of data inference by being applied to IoT semantic services.

### BRIEF DESCRIPTION OF DRAWINGS

FIG. 1 is an exemplary diagram illustrating a concept of a method for data parallel inference according to embodiments of the present invention.

FIG. 2 is an exemplary diagram illustrating a process for generating a Rete network and indexing Fact according to an embodiment of the present invention.

FIG. 3 is an exemplary diagram illustrating RDFS-based inference rules according to an embodiment of the present invention.

FIG. 4 is an exemplary diagram for parsing and storing rules in a rule structure(rules) according to an embodiment of the present invention.

FIG. 5 is an exemplary diagram illustrating a process for generating a Rete network according to an embodiment of the present invention.

FIG. 6 illustrates a Rete network generated according to an embodiment of the present invention.

FIG. 7A and FIG. 7B illustrate a data inference process on a Rete network according to an embodiment of the present invention.

FIG. 8 is a flowchart illustrating a method for data parallel inference according to an embodiment of the present invention.

FIG. 9 is a block view illustrating an apparatus for data parallel inference to which embodiments of the present invention are applied.

### DESCRIPTION OF EXEMPLARY EMBODIMENTS

Throughout the description of the present invention, when describing a certain technology is determined to evade the point of the present invention, the pertinent detailed description will be omitted.

In descriptions of the present invention, semantic services mean services represented in resource description framework(RDF), RDF schema(RDFS) and web ontology language(OWL) which are world wide web consortium(W3C) semantic web standards which are used for default data representation.

Exemplary embodiments of the present invention can be applied to data model(schema), particularly a RDF-based data model, which is represented in RDFS representation among W3C semantic web standard representations. RDFS represents relation between schema and data by generally using vocabularies such as rdfs:subClassOf, rdfs:subPropertyOf, rdfs:domain and rdfs:range, etc.

In descriptions of exemplary embodiment of the present invention, the parallel inference means an inference method for processing each of a plurality of partial works, which are divided from the work in each stage for inference on the semantic web, with separate processors.

Exemplary embodiments of the present invention provide a method for data parallel inference using numerous RDFS-based sensor data generated in IoT environment for efficient semantic services.

A method for data parallel inference according to exemplary embodiments of the present invention can be performed based on RDF data defined using Hadoop database(HBase) which is a representation method of information of big data.

In exemplary embodiments of the present invention, inference can be performed using various algorithms relating to rule inference. In an embodiment, inference can be performed using a Rete algorithm which is one of rule inference algorithms.

The Rete algorithm establishes a Rete network formed in a network data structure format to determine if conditions satisfy rules or not. The Rete network is very efficient network for matching facts(hereinafter, referred to as data or input data) against the patterns in rules. Matching test information with newly inputted data is stored in each node of the Rete network. When data is inputted to an inference apparatus, test is performed in each node and the data which has passed the test is inputted to a sub-node to be performed for the test. When data, which reaches a leaf node by passing all tests in the network structure, is present, the rules are satisfied for the final condition.

The Rete network is divided into a pattern network and a join network according to functions and configurations. The pattern network is a network performing a pattern matching test for each pattern included in rules and the join network is a network performing a matching test between patterns of the data which has passed each pattern matching test.

In exemplary embodiments of the present invention, Map of MapReduce is built to perform each pattern matching test in parallel and a method for performing Reduce function of MapReduce, which conducts join functions by collecting results from the pattern matching test, is provided. Test result from each node is indexed to each node, so that a repeated test for the data, which is already performed, can be avoided.

Exemplary embodiments of the present invention can be performed based on a traditional Rete algorithm, perform indexing function of the pattern network in parallel which processes the pattern matching test, and perform indexing function of the join network which processes the matching test between patterns with the result from the pattern matching test.

Exemplary embodiments of the present invention will be described below with reference to the accompanying drawings.

In descriptions of exemplary embodiment of the present invention, although a method for performing data inference will be described with using a Rete algorithm which is one of rule inference algorithms and a Rete network, it is to be appreciated that it may not be limited thereto but it may be performed based on various rule inference algorithms.

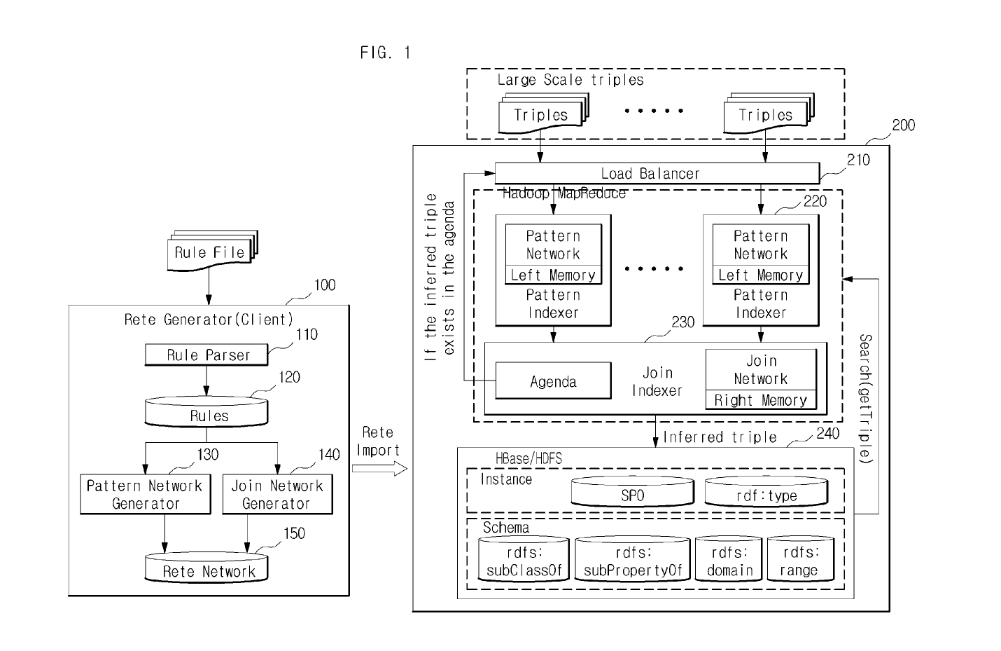

FIG. 1 is an exemplary diagram illustrating a concept of a method for data parallel inference according to embodiments of the present invention.

Referring to FIG. 1, an apparatus for data parallel inference according to embodiments of the present invention comprises a Rete generator 100, a load balancer 210 distributing inputted data, a plurality of pattern indexers 220 performing data pattern indexing, a join indexer 230 performing data join indexing, and a HBase/HDFS(Hadoop Distributed File System)-based data model 240 storing RDF-based data. Some of components can be omitted according to embodiments.

A rule parser 110 performs parsing by receiving a rule file and stores the result in a rule structure(rules) 120. A pattern network generator 130 and a join network generator 140 generate a pattern network and a join network by referring the rule structure(rules) 120, respectively. A Rete network 150 composed of the pattern network and the join network is imported to internal memories of the plurality of pattern indexers 220 which are Hadoop MapReduce-based Map and an internal memory of the join indexer 230 which is Hadoop MapReduce-based Reduce.

The load balancer 210 distributes evenly inputted data (triple-typed Facts) to each Hadoop MapReduce-based Map.

The pattern indexers 220 perform a pattern matching test based on the pattern network imported from the Rete generator 100 and the data inputted from the load balancer 210. The pattern matching test is performed in parallel and the data which has passed the pattern matching test can be indexed to a Left(Alpha) Memory of the pattern network.

The data which has passed the pattern matching test is inputted to the join indexer 230. The join indexer 230 performs a join matching test based on the join network imported from the Rete generator 100 and the data which has passed the pattern matching test. The data which has passed the join matching test can be indexed to a Right (Beta) Memory of the join indexer 230.

The data which has passed the join matching test finally is used as an input value of Agenda. If data indexed in the Right(Beta) Memory is present, it means that data which has passed corresponding rules is present and is used to perform Action of the rules in the Agenda. As a result, new data is inferred and stored. The inferred new data is again inputted to the load balancer and processed for next cycle. All cycles are repeated till there is no newly added data in the Agenda.

Data, for example inputted facts and inferred facts, may be stored in the HBase/HDFS-based data model 240. The HBase/HDFS-based data model 240 may provide common application programming interface(API) to manage (including at least one of store, query, delete and modify) each data.

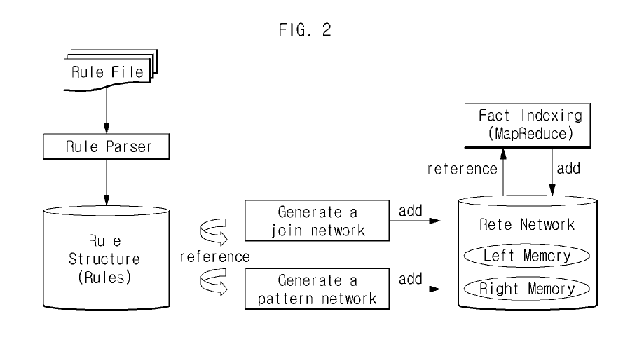

FIG. 2 is an exemplary diagram illustrating a process for generating a Rete network and indexing Fact according to an embodiment of the present invention.

An apparatus for data parallel inference according to an embodiment of the present invention parses rule files and stores them in a rule structure(Rules). The apparatus for data parallel inference according to an embodiment of the present invention generates and stores pattern/join network based on the stored rules. As described by referring to FIG. 1 above, the generated Rete network is imported to each internal memories of pattern indexers which are Hadoop MapReduce-based Maps and a join indexer which is Hadoop MapReduce-based Reduce.

When triple-typed data to be used for data inference is inputted, a pattern matching test and a join matching test are performed based on the Rete network, and the data which have passed the tests is indexed and stored to each of the Left(Alpha) Memory and the Right(Beta) memory.

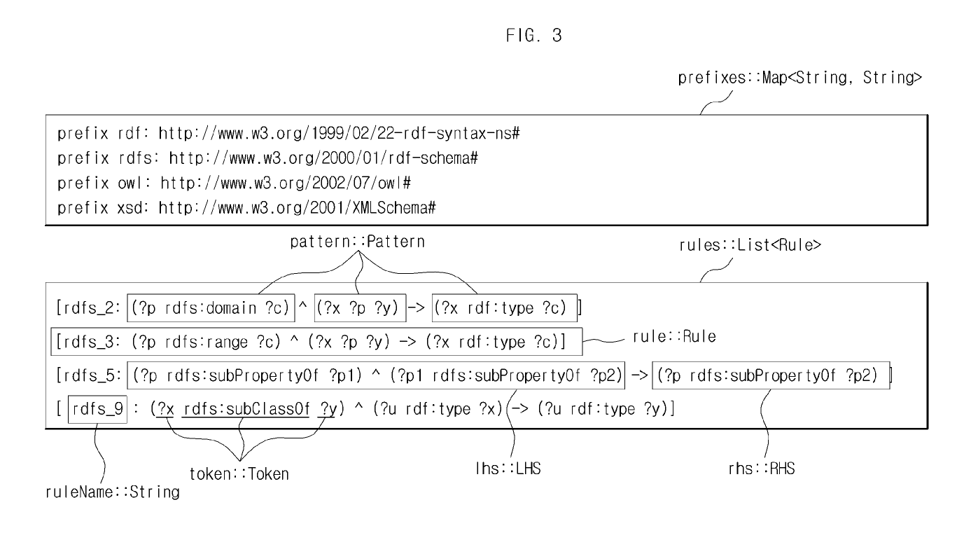

FIG. 3 is an exemplary diagram illustrating RDFS-based inference rules according to an embodiment of the present invention.

The rule file includes prefix information and rule information which is stored in a list form. Each rule is configured with a rule name, a condition part representing condition and an executing part representing action.

The condition part may be a Left hand side(LHS) and the executing part may be a Right hand side(RHS). The condition part and the executing part may be composed of a set of patterns and each pattern has a triple token structure.

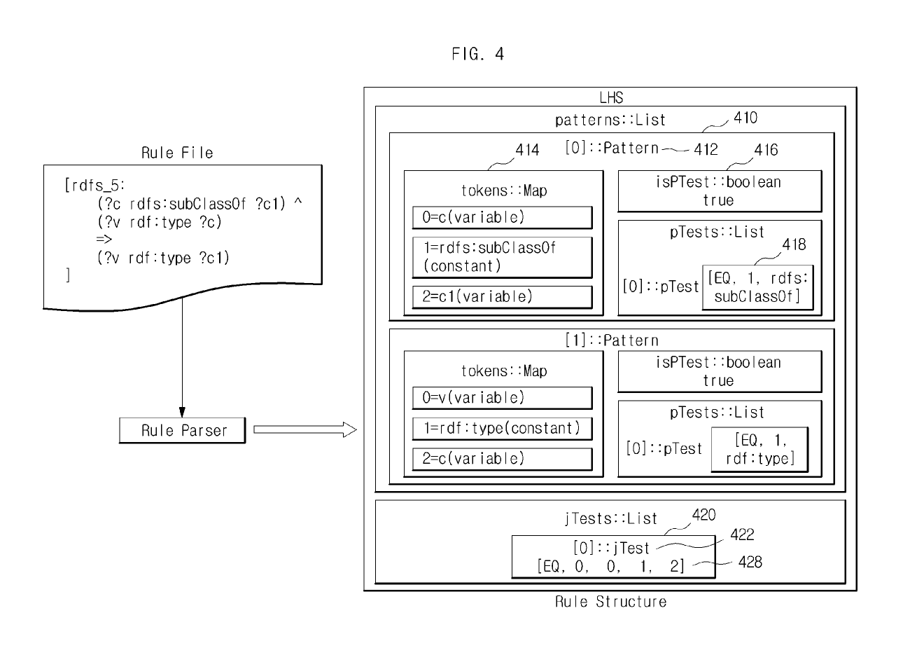

FIG. 4 is an exemplary diagram for parsing and storing rules in a rule structure(rules) according to an embodiment of the present invention.

As shown in FIG. 4, rules are stored in one LHS data structure. The LHS includes information used for the pattern matching test and information used for the join matching test.

The information 410 used for the pattern matching test may include at least one of identification information 412 of each pattern, token information 414 included in each pattern, information 416 representing if a pattern matching test for each pattern is performed or not, and an operation expression 418 used at the time of a pattern matching test for each pattern.

In FIG. 4, a rule(rdfs_{—}5) is composed of 2 patterns of (?c rdfs:subClassOf ?c1) and (?v rdf:type ?c) and each pattern is composed of 3 tokens. The tokens are stored in a data structure type having key values of 0, 1, and 2 depending on the position in the pattern.

The token information 414 may include at least one of a key value of a corresponding token, an attribute of a corresponding token (for example, if it is a constant value or a variable value) and a vocabulary of a corresponding token.

The information 416 representing if a pattern matching test for each pattern is performed or not may be stored in a Boolean type. For example, when a pattern matching test for a corresponding pattern is performed, the corresponding Boolean value may be changed from ‘false’ to ‘true’. For example, when the Boolean value is ‘true’, the pattern matching test for the same pattern may be skipped.

The operation expression 418 is used during the pattern matching test for a corresponding pattern. For example, an operation expression [EQ, 1, rdfs: subClassOf] means that it passes the corresponding pattern matching test when the token having a key value of 1, which is the token positioned at the second in the patterns, is rdfs: subClassOf. The test operation information may be represented by Operator: EQ, TokenIndex: 1 and Operand: rdfs:subClassOf and a pTest value is stored as EQ, 1, rdfs:subClassOf] in the LHS. A pTest value of the second pattern is store as [EQ, 1, rdf:type] by the same manner.

The information 420 used for the join matching test includes at least one of identification information 422 of the join matching test to be performed for a corresponding rule and an operation expression 428 used at the time of the join matching test for the LHS. An operation expression [EQ, 0, 0, 1, 2] means a test to determine if a token(the first token) having a key value of 0 included in a pattern(the first pattern) having a key value of 0 is equal to a token(the third token) having a key value of 2 included in a pattern(the second pattern) having a key value of 1.

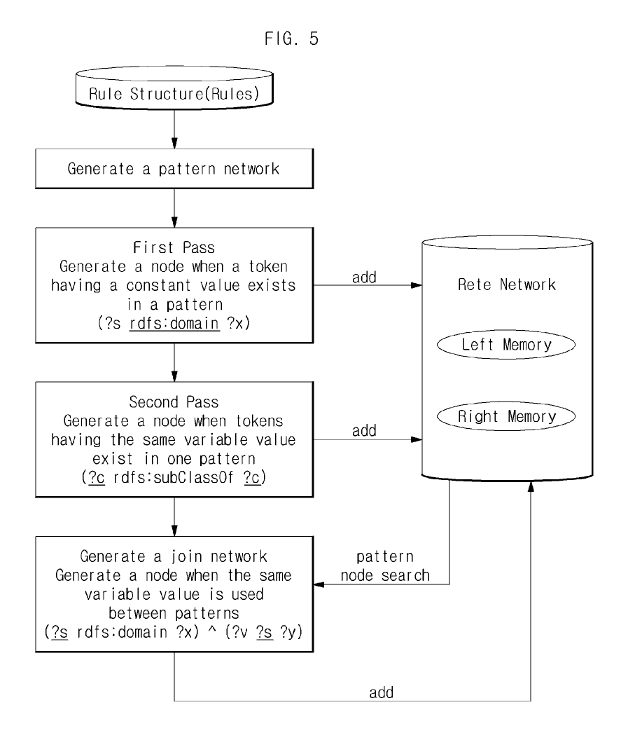

FIG. 5 is an exemplary diagram illustrating a process for generating a Rete network according to an embodiment of the present invention.

The step of generating a Rete network may be divided into a step for generating a pattern network and a step for generating a join network.

The step for generating a pattern network may include at least one of the First Pass step and the Second Pass step.

The First Pass step is a step for generating a pattern node in the pattern network when a token value which exists in one pattern is not a variable value but a constant value. For example, since the second token value in one pattern (?s rdfs:domain ?x) is a constant value(rdfs:domain), a pattern node can be generated in the pattern network. The pattern matching test to determine if the second token of newly inputted data is rdfs:domain or not is performed in a corresponding pattern node, so that the test may be defined as [Test that the value of token_{—}1 is equal to constant rdfs:domain].

The Second Pass step is a step for generating a pattern node in the pattern network when tokens having the same variable value exist in one pattern. For example, it may be noted that the first token and the third token have the same variable value(?c) in one pattern (?c rdfs:subClassOf ?c). Thus, a pattern node may be generated in the pattern network and the test may be defined as [Test that the value of token_{—}0 is equal to the value of token_{—}2].

The step of generating a join network determines if tokens having the same variable value exist in common in patterns included in one LHS. For example, it may be noted that the first token value(?s) of the first pattern (?s rdfs:domain ?x) is equal to the second token value(?s) of the second pattern (?v ?s ?y) in 2 patterns of (?s rdfs:domain ?x) ̂ (?v ?s ?y). In this case, a join node is generated in the join network. The test may be defined as [Test that the value of token_{—}0 of pattern_{—}0 is equal to the value of token_{—}1 of pattern_{—}1] in the corresponding join node.

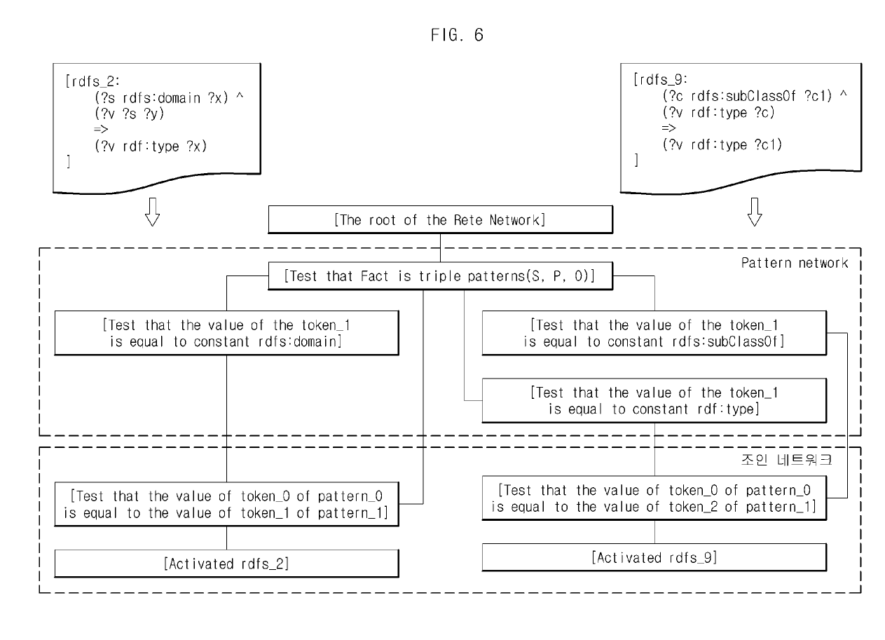

FIG. 6 illustrates a Rete network generated according to an embodiment of the present invention.

FIG. 6 illustrates a Rete network generated from the step for generating a pattern network and the step for generating a join network as described in FIG. 5.

Referring to FIG. 6, since the second token(rdfs:domain) of the first pattern(?s rdfs:domain ?x) of rule 2(rdfs_{—}2) is a constant value, it may be noted that a pattern node([Test that the value of the token_{—}1 is equal to constant rdfs:domain] is generated in the pattern network through the first pass step of the step for generating a pattern network.

In addition, since the first token(?s) of the first pattern of rule 2(rdfs_{—}2) is equal to the second token(?s) of the second pattern of rule 2(rdfs_{—}2), it may be noted that a join node([Test that the value of token_{—}0 of pattern_{—}0 is equal to the value of token_{—}1 of pattern_{—}1]) is generated in the join network through the step for generating a join network.

It may be also noted that a pattern node([Test that the value of the token_{—}1 is equal to constant rdfs:subClassOf]) for the second token(rdfs:subClassOf) of the first pattern(?c rdfs:subClassOf ?c1) of rule_{—}9(rdfs_{—}9) and a pattern node([Test that the value of the token_{—}1 is equal to constant rdf:type]) for the second token(rdf:type) of the second pattern(?v rdf:type ?c) of rule 9(rdfs_{—}9) are generated through the first pass step of the step for generating a pattern network.

Furthermore, since the first token(?c) of the first pattern of rule 9(rdfs_{—}9) is equal to the third token(?c) of the second pattern of rule 9(rdfs_{—}9), it may be noted that a join node([Test that the value of token_{—}0 of pattern_{—}0 is equal to the value of token_{—}2 of pattern_{—}1]) is generated in the join network according to the step for generating a join network.

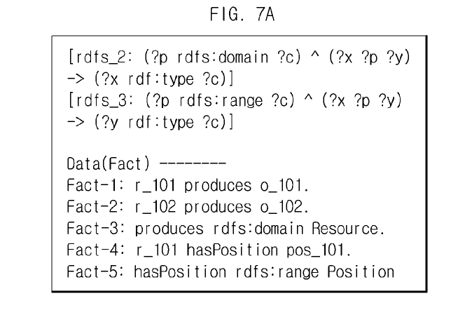

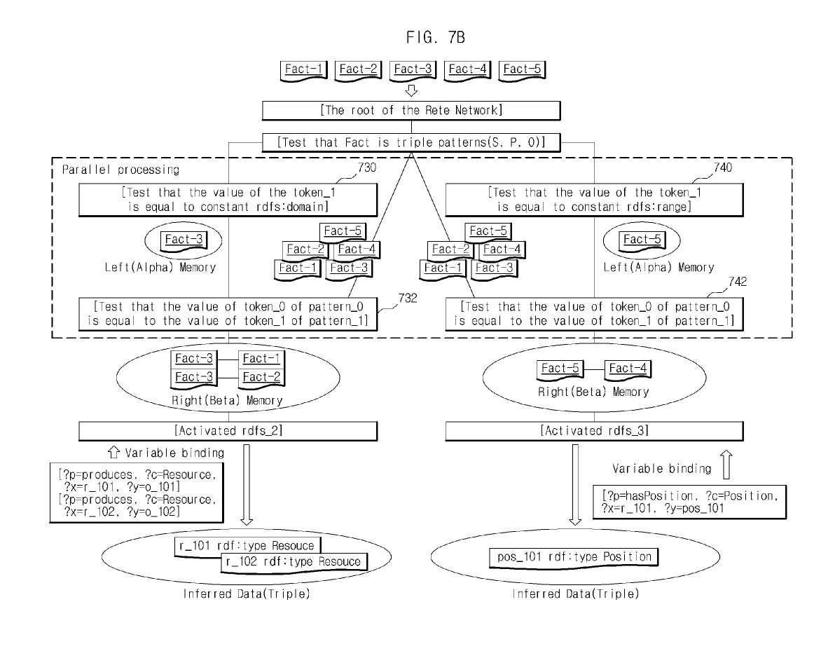

FIG. 7A and FIG. 7B illustrates a data inference process on a Rete network according to an embodiment of the present invention.

FIG. 7A illustrates rules 710 and triple-typed input data 720 and FIG. 7B illustrates a process for performing data parallel inference by applying the inputted data 720 in the Rete network generated based on the rules 710.

Pattern nodes 730 and join nodes 732 are nodes generated based on the rule 2(rdfs_{—}2) and pattern nodes 740 and join nodes 742 are nodes generated based on the rule 3(rdfs_{—}3). Since a process for generating the nodes is the same as that described by referring to FIG. 5 and FIG. 6, the detailed description therefor is omitted.

When it is assumed that the inputted data 720 is as shown in FIG. 7A, an apparatus for data parallel inference performs the pattern matching test in parallel based on the inputted data 720 and the Rete network. This is explained in more detail as follows.

The inputted data 720 is inputted to each of the pattern nodes 730, 740. That is, the inputted data 720 of Fact-1 to Fact-5 is inputted to the pattern node 730 and the inputted data 720 of Fact-1 to Fact-5 is also inputted to the pattern node 740.

The pattern matching test is performed in parallel in each of the pattern nodes 730, 740.

A condition to pass the test in the pattern node 730 is whether the second token(token_{—}1) has a constant value(rdfs:domain). It is noted that Fact-3 among 5 input data 720 satisfies the condition. Therefore, the Fact-3 is indexed in the Left(Alpha) Memory of the pattern node 730.

A condition to pass the test in the pattern node 740 is whether the second token(token_{—}1) has a constant value(rdfs:range). It is noted that Fact-5 among 5 input data 720 satisfies the condition. Therefore, the Fact-5 is indexed in the Left(Alpha) Memory of the pattern node 740.

The data which has passed the pattern matching test, that is, the data(Fact-3, Fact-5) indexed in the Left(Alpha) Memory, is used as input for the join matching test.

The join matching test is performed in the join nodes 732, 742 by using the data(Fact-3, Fact-5) which has passed the pattern matching test and the inputted data 720.

A condition to pass the test in the join node 732 is whether the first token(token_{—}0) of the first pattern(pattern_{—}0) is equal to the second token(token_{—}1) of the second pattern(pattern_{—}1). When it is assumed that the first pattern(pattern_{—}0) is Fact-3, the first token(token_{—}0) of the first pattern(pattern_{—}0) is ‘produces’. It is then noted that the data in which the second token(token_{—}1) is ‘produces’ is Fact-1 and Fact-2. Accordingly, (Fact-3-Fact-1, Fact-3-Fact-2) is indexed in the Right(Beta) Memory of the join node 732.

A condition to pass the test in the join node 742 is whether the first token(token_{—}0) of the first pattern(pattern_{—}0) is equal to the second token(token_{—}1) of the second pattern(pattern_{—}1). When it is assumed that the first pattern(pattern_{—}0) is Fact-5, the first token(token_{—}0) of the first pattern(pattern_{—}0) is ‘hasPosition’. It may be noted that the data, in which the second token(token_{—}1) among the inputted data 720 is ‘hasPosition’, is Fact-4. Accordingly, (Fact-5-Fact-4) is indexed in the Right(Beta) Memory of the join node 742.

The data indexed in the join nodes 732, 742 is inputted as an Activated node, respectively, and is changed to a variable value through a variable binding process. New data is inferred by executing action part(RHS) of the corresponding rule.

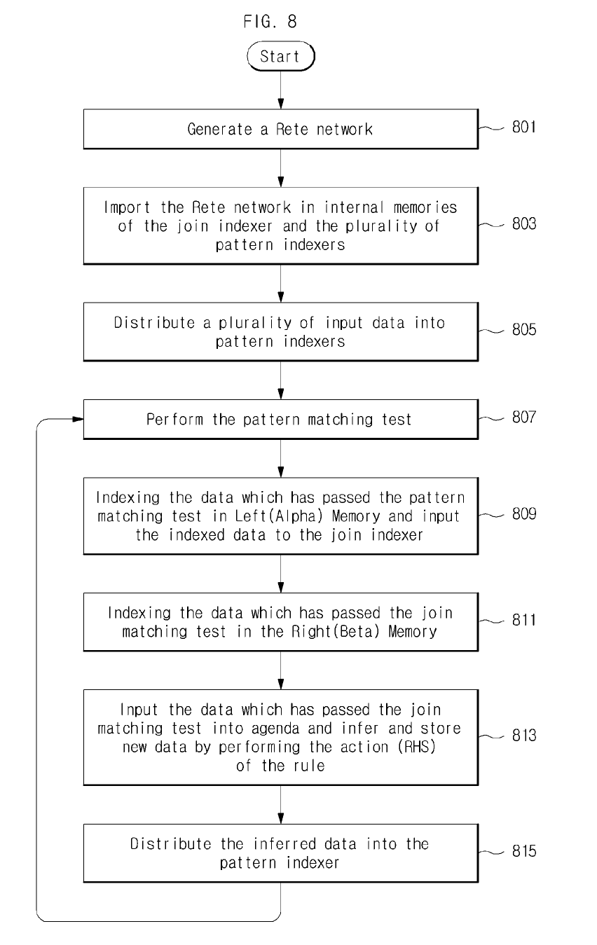

FIG. 8 is a flowchart illustrating a method for data parallel inference according to an embodiment of the present invention.

In S801, a Rete network is generated. The Rete network may be generated based on rules and a Rete algorithm. The Rete network may be generated according to the step for generating a pattern network and the step for generating a join network as described by referring to FIG. 5.

In S803, the Rete network is loaded in internal memories of the join indexer and the plurality of pattern indexers. For example, the pattern network may be loaded to each internal memory of the plurality of pattern indexers. The join network may be loaded in the internal memory of the join indexer.

In S805, a plurality of input data is distributed into pattern indexers.

In S807, the pattern matching test is performed in each pattern indexer. The pattern matching test is performed in pattern indexers in parallel.

In S809, the data which has passed the pattern matching test is indexed in the Left(Alpha) Memory and the indexed data is inputted to the join indexer.

In S811, the join matching test is performed based on the data indexed in the Left(Alpha) Memory and the inputted data. The data which has passed the join matching test is indexed in the Right(Beta) Memory.

In S813, the data which has passed the join matching test is inputted as Agenda and new data is inferred by performing the action part(RHS) of the rule. The inferred data may be stored in HBase/HDFS.

In S815, the inferred data is used for new data inference by being distributed into the pattern indexer.

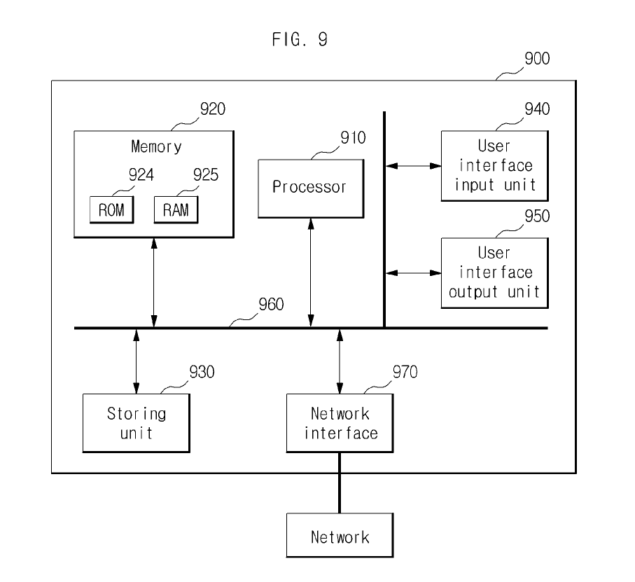

Exemplary embodiments of the present invention may be implemented in a computer system, for example, a computer readable recording medium. As shown in FIG. 9, a computer system 900 may include at least one of at least one processor 910, a memory 920, a storing unit 930, a user interface input unit 940 and a user interface output unit 950. The computer system 900 may further include a network interface 970 to connect to a network. The processor 910 may be a CPU or semiconductor device which executes processing commands stored in the memory 920 and/or the storing unit 930. The memory 920 and the storing unit 930 may include various types of volatile/non-volatile storage media. For example, the memory may include ROM 924 and RAM 925.

Accordingly, exemplary embodiments of the present invention may be implemented by a method implemented with a computer or by a non-volatile computer recording medium in which computer executable commands are stored. The commands may be performed by at least one embodiment of the present invention when they are executed by the processor.

What is claimed is:

1. A method for data parallel inference comprising:
generating a predetermined network comprising a pattern network and a join network based on rule files and a predetermined algorithm;
performing a pattern matching test for input data in parallel on a plurality of pattern matching means by loading the pattern network to each of the plurality of pattern matching means and distributing the inputted data to the plurality of pattern matching means; and
inferring new data by performing a join matching test for the data which has passed the pattern matching test.

2. The method for data parallel inference of claim 1, wherein the generating a predetermined network comprises:
forming information to be used for the pattern matching test and the join matching test by analyzing condition part of each rule included in the rule files; and
generating a predetermined network by using the formed information.

3. The method for data parallel inference of claim 2, wherein the information to be used for the pattern matching test comprises at least one of identification information of each pattern composing the condition part, token information included in a corresponding pattern, information indicating whether the pattern matching test for a corresponding pattern is performed or not, and an operation expression which is used at the time of the pattern matching test for a corresponding pattern.

4. The method for data parallel inference of claim 2, wherein the information to be used for the join matching test comprises at least one of identification information of the join matching test to be performed for a corresponding rule and an operation expression which is used at the time of the join matching test for the condition part.

5. The method for data parallel inference of claim 2, wherein the generating a predetermined network comprises, when a token having a constant value exists in a pattern, generating a pattern node which performs the pattern matching test for the corresponding token on the pattern network.

6. The method for data parallel inference of claim 2, wherein the generating a predetermined network comprises, when tokens having the same variable value exist in one pattern, generating a pattern node which performs the pattern matching test for the corresponding token on the pattern network.

7. The method for data parallel inference of claim 2, wherein the generating a predetermined network comprises, when tokens having the same variable value exists in common in patterns included in one condition part, generating a join node which performs the join matching test for the corresponding token on the join network.

8. The method for data parallel inference of claim 1, wherein the performing a pattern matching test comprises:
loading the join network to one join matching means; and
performing the join matching test, using the data which has passed the pattern matching test and the inputted data, on the join matching means.

9. The method for data parallel inference of claim 1, further comprising indexing the result from the pattern matching test and the join matching test to each of the pattern node and the join node.

10. The method for data parallel inference of claim 2, wherein the predetermined algorithm is a Rete algorithm, the predetermined network is a Rete network, and the condition part is left hand side(LHS).

11. An apparatus for data parallel inference comprising a processor and a memory,
wherein the memory stores commands to generate a predetermined network and perform data parallel inference,
the commands comprises, when performed by the processor, commands for the processor to:
generate a predetermined network comprising a pattern network and a join network based on rule files and a predetermined algorithm;
perform a pattern matching test for input data in parallel on a plurality of pattern matching means by loading the pattern network to each of the plurality of pattern matching means and distributing the inputted data to the plurality of pattern matching means; and
infer new data by performing a join matching test for the data which has passed the pattern matching test.

12. The apparatus for data parallel inference of claim 11, wherein the commands comprises commands for the processor to form information to be used for the pattern matching test and the join matching test by analyzing condition part of each rule included in the rule files; and generate a predetermined network by using the formed information.

13. The apparatus for data parallel inference of claim 12, wherein the information to be used for the pattern matching test comprises at least one of identification information of each pattern composing the condition part, token information included in a corresponding pattern, information indicating whether the pattern matching test for a corresponding pattern is performed or not, and an operation expression which is used at the time of the pattern matching test for a corresponding pattern.

14. The apparatus for data parallel inference of claim 12, wherein the information to be used for the join matching test comprises at least one of identification information of the join matching test to be performed for a corresponding rule and an operation expression which is used at the time of the join matching test for the condition part.

15. The apparatus for data parallel inference of claim 12, wherein the commands comprises commands for the processor to generate a pattern node which performs the pattern matching test for a token on the pattern network, the token having a constant value.

16. The apparatus for data parallel inference of claim 12, wherein the commands comprises commands for the processor to generate a pattern node which performs the pattern matching test for tokens on the pattern network, the tokens having the same variable value in one pattern.

17. The apparatus for data parallel inference of claim 12, wherein the commands comprises commands for the processor to generate a join node which performs the join matching test for tokens on the join network, the tokens having the same variable value in patterns included in one condition part.

18. The apparatus for data parallel inference of claim 11, wherein the commands comprises commands for the processor to load the join network to one join matching means; and perform the join matching test, using the data which has passed the pattern matching test and the inputted data, on the join matching means.

19. The apparatus for data parallel inference of claim 11, wherein the commands comprises commands for the processor to index the result from the pattern matching test and the join matching test to each of the pattern node and the join node.

20. The apparatus for data parallel inference of claim 12, wherein the predetermined algorithm is a Rete algorithm, the predetermined network is a Rete network, and the condition is left hand side(LHS).
